(19) United States
(12) Patent Application Publication
(10) Pub. No.: US 2016/0122596 A1
(43) Pub. Date: May 5, 2016

(54) FILLER FOR ANTI-VIBRATION SEALER AND EPOXY-BASED ANTI-VIBRATION SEALER COMPOSITION INCLUDING THE SAME

(71) Applicant: Hyundai Motor Company, Seoul (KR)

(72) Inventor: Sung Chul Shin, Incheon (KR)

(21) Appl. No.: 14/924,780

(22) Filed: Oct. 28, 2015

(30) Foreign Application Priority Data
Oct. 31, 2014 (KR) 10-2014-0150083

(51) Int. Cl. C09J 11/04; B05D 3/00; C09J 9/00; B05D 7/00; C09J 163/00; C09J 7/00

(52) U.S. Cl. CPC C09J 11/04; C09J 163/00; C09J 7/00; C09J 9/00; B05D 7/546; B05D 3/007

(57) ABSTRACT

The present invention relates to a filler for an anti-vibration sealer and an epoxy-based anti-vibration sealer composition including the filler. In particular, the filler of the anti-vibration sealer is double coated calcium carbonate that comprises a nitrile butadiene rubber (NBR) coating layer and an acrylic resin coating layer as being laminated on the surface of calcium carbonate particles. As such, the anti-vibration sealer composition according to the present invention provides improved anti-vibration property by including the double coated calcium carbonate as the filler.

This application claims under 35 U.S.C. §119(a) the benefit of Korean Patent Application No. 10-2014-0150083 filed Oct. 31, 2014, the entire contents of which are incorporated herein by reference.

### TECHNICAL FIELD

The present invention relates to a filler for an anti-vibration sealer and an epoxy-based anti-vibration sealer composition including the filler. In particular, the filler may comprise calcium carbonate that comprises 1) a nitrile butadiene rubber (NBR) coating layer and 2) an acrylic resin coating layer formed on the surface of a calcium carbonate particle. According to the present invention, the anti-vibration sealer composition may have an improved anti-vibration property by including the double coated calcium carbonate particles as a filler therein in addition to an epoxy-based base resin, a dicyandiamide epoxy curing agent and other additives.

### BACKGROUND

An anti-vibration material generally refers to a material used for reducing vibrations and noises. For example, in a vehicle, the anti-vibration material may be installed in the form of a sheet to reduce vibration and provide soundproof performances by being thermoset with heat from a paint oven in the vehicle. An asphalt-type anti-vibration sealer has been most widely used as an anti-vibration product in the art.

The asphalt-type anti-vibration sealer includes asphalt pitch as a main component. An asphalt pitch sheet generally has very strong adhesion, such that the asphalt sheet tis occasionally coated with talc during handwork on the sheet surface in order to prevent contamination when desorbing or adhering to the gloves or hands. However, the coated talc causes air pollution with dust particles during handwork in a working area, which may be taken into the body of a worker, or may be adhered to a car body causing contamination. In addition, such asphalt pitch may generate oil when passing through a high-temperature oven during a painting process, which makes painting process difficult.

Accordingly, in the related arts, for remedying disadvantages of the asphalt-type anti-vibration sealer, a great number of anti-vibration sealers providing impact resistance by using an epoxy resin as a base resin have been developed. However, although a stiffening effect is quite satisfactory with the use of the epoxy resin, an anti-vibration effect has not been sufficiently improved.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to solve the above-described problems in the related art. In preferred aspects, the present invention provides an epoxy-based anti-vibration sealer composition having an improved anti-vibration property as well as improved stiffness.

In one aspect, the present invention provides a filler for an epoxy-based anti-vibration sealer. The filler may comprise calcium carbonate that comprises 1) a nitrile butadiene rubber (NBR) coating layer and 2) an acrylic resin coating layer in consecutive order on a surface of the calcium carbonate. In particular, 1) the nitrile butadiene rubber (NBR) coating layer and 2) the acrylic resin coating layer may be laminated in consecutive order on particles of the calcium carbonate.

In another aspect, the present invention provides a method for preparing a filler for an epoxy-based anti-vibration sealer. The method may include: preparing a first coating process of preparing NBR-coated calcium carbonate particles and a second coating process of preparing a double-coated calcium carbonate particles. In the first coating process, 1)calcium carbonate particles may be deposited in a first coating solution including nitrile butadiene rubber (NBR) in an amount of about 20 to 50% by weight and butyl cellosolve in an amount of about 50 to 80% by weight, with respect to the total weight of the first coating solution; 2) the NBR-deposited calcium carbonate particles may be removed from the first coating solution; and 3) the calcium carbonate particles may be cured for about 15 to 30 minutes at a temperature of about 130 to 140° C. In the second coating process of preparing calcium carbonate particles double coated with the NBR and an acrylic resin, 1) the NBR-coated calcium carbonate particles may be deposited in a second coating solution including an acrylic resin in an amount of about 20 to 50% by weight and butyl cellosolve in 50 to 80% by weight, with respect to the total weight of the second coating solution; 2) the acryl deposited calcium carbonate particles may be removed from the second coating solution; 3) the calcium carbonate particles may be cured for about 15 to 30 minutes at a temperature of about 130 to 140° C.

Further, the present invention provides an epoxy-based anti-vibration sealer composition that may include an epoxy resin, an epoxy curing agent, a tackifier, a filler and an additive. In particular, the double coated calcium carbonate that includes a nitrile butadiene rubber (NBR) coating layer and an acrylic resin coating layer as being laminated in consecutive order on a surface of calcium carbonate particles as described above may be included in the composition as the filler.

In a further aspect, the present invention provides an anti-vibration sheet including the epoxy-based anti-vibration sealer composition as described herein.

Still further provided is a vehicle part that comprises the epoxy-based anti-vibration sealer composition including the double-coated calcium carbonate as a filler as described herein. Exemplary vehicle part may be, but not limited to, an anti-vibration sheet.

Other aspects and preferred embodiments of the invention are discussed infra.

The above and other features of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a cross-sectional view of an exemplary double-coated calcium carbonate filler according to an exemplary embodiment of the present invention; and

FIG. 2 schematically illustrates an exemplary anti-vibration sheet according to an exemplary embodiment of the present invention.

It should be understood that the appended drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The present invention relates to a filler of an epoxy-based anti-vibration sealer using calcium carbonate that may be double coated with organic resins as, a method for preparing the filler, an epoxy-based anti-vibration sealer composition including the filler, and an anti-vibration sheet prepared by molding the epoxy-based anti-vibration sealer composition.

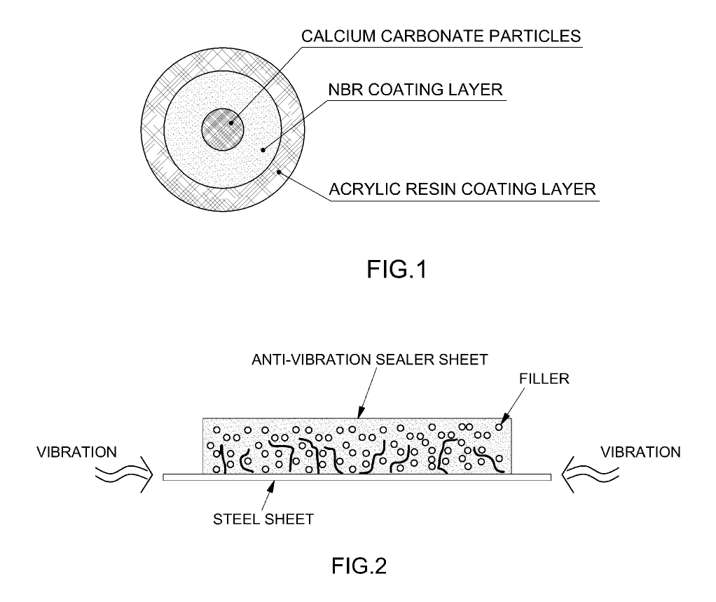

In one aspect, the filler may be double coated calcium carbonate. As shown in FIG. 1, an organic coating layer of nitrile butadiene rubber (NBR) and an organic coating layer of an acrylic resin may be laminated in consecutive order on the surface of calcium carbonate particles.

In an exemplary embodiment of the present invention, the filler may comprise: calcium carbonate that may comprise 1) a nitrile butadiene rubber (NBR) and 2) an acrylic resin as coating layers. In particular, 1) the nitrile butadiene rubber (NBR) and 2) the acrylic resin may be laminated in consecutive order on a surface of the calcium carbonate particles. A first coating layer may be formed with the nitrile butadiene rubber (NBR) and the NBR may be laminated in an amount of about 10 to 50% by weight with respect to the weight of the calcium carbonate particles. When the weight of the NBR coating layer is less than about 10% by weight with respect to the weight of the calcium carbonate particles, anti-vibration efficiency may not be improved, and when the weight is greater than about 50% by weight, adhesion efficiency of a sealer may be hindered.

In addition, a second coating layer may be formed with the acrylic resin that may be laminated in an amount of about 10 to 50% by weight with respect to the weight of the calcium carbonate particles. When the weight of the acrylic resin coating layer is less than about 10% by weight with respect to the weight of the calcium carbonate particles, anti-vibration efficiency may not be improved, and when the weight is greater than about50% by weight, adhesion efficiency of a sealer may be hindered.

Further, provided is a method for preparing double coated calcium carbonate used as the filler as described as follows.

First, calcium carbonate particles may be deposited in a first coating solution including nitrile butadiene rubber (NBR) in an amount of about 20 to 50% by weight and butyl cellosolve in an amount of about 50 to 80% by weight with respect to the total weigh to of the first coating solution, and the resulting mixture may be stirred for about 1 to 2 hours. The particles may be subsequently removed from the first coating solution and heat cured for about 15 to 30 minutes at a temperature of about 130 to 140° C. to obtain NBR-coated calcium carbonate particles. Next, the NBR-coated calcium carbonate particles prepared above may be deposited in a second coating solution including an acrylic resin in an amount of about 20 to 50% and butyl cellosolve in an amount of about 50 to 80% by weight based on the total weight of the second coating solution, and the resulting mixture may be stirred for about 1 to 2 hours. The particles may be subsequently removed from the second coating solution and heat cured for about 15 to 30 minutes at a temperature of about 130 to 140° C. to obtain double coated calcium carbonate particles that are laminated with the NBR and the acrylic resin.

When the content of the resin is less than about 20% by weight in preparing the first coating solution and the second coating solution, coating may not be obtained sufficiently since the fluidity of the coating agent is reduced due to the excessive solvent amount, and when the content of the resin is greater than about 50% by weight, the resin may not be uniformly dispersed into the coating solution thereby causing agglomeration due to the insufficient amount of the solvent, which may further form a non-uniform thickness of the coating layer.

In addition, when the stiffing time is less than the predetermined time, for example, less than about 1 hour, in the first coating and the second coating processes, uncoated calcium carbonate particles may remain, and when such calcium carbonate particles are used as a filler, anti-vibration efficiency may not be improved sufficiently. When the stirring time is greater than the predetermined time, for example, greater than about 2 hours, manufacturing cost may increase.

Furthermore, when the curing temperature is less than the predetermined temperature range, for example, less than about 130° C., or the curing time is less than the predetermined time, for example, less than about 15 minutes in curing the coated particles, uncoated calcium carbonate may remain and reduce anti-vibration efficiency improvement. When the curing temperature is greater than the predetermined temperature range, for example, greater than about 140° C., or the curing time is greater than the predetermined time, for example, greater than about 30 minutes, elasticity may be reduced in the NBR first coating layer, and cracks may occur in the acrylic resin second coating layer.

The anti-vibration sealer composition according to an exemplary embodiment of the present invention may include an epoxy resin in an amount of about 30 to 70% by weight, an epoxy curing agent in an amount of about 3 to 10% by weight, a tackifier in an amount of about 3 to 5% by weight, a filler in an amount of aboutl5 to 40% by weight, and an additive in an amount of about 1 to 15% by weight, with respect to the total weight of the anti-vibration sealer composition.

Constituents and composition ratios of the anti-vibration sealer composition are described in detail as follows.

(1) Epoxy Resin

As used herein, an epoxy resin may be used as a base resin. The epoxy resin generally has strong corrosion resistance while having excellent impact resistance, durability and the like, and has been commonly used as a base resin of an anti-vibration sealer. Such an epoxy-based anti-vibration sealer may well function as a stiffener for vehicle body structures and may be used as a substitute for metal stiffeners. The epoxy resin used in the present invention may be commonly used in the related art such as an anti-vibration sealer manufacturing field, and selection thereof may not be particularly limited thereto. Particularly, when a bisphenol A-type epoxy resin is used among epoxy resins, stiffening effect of an anti-vibration sealer may be maximized.

The anti-vibration sealer composition may include the epoxy resin in an amount of about 30 to 70% by weight or particularly in an amount of about 40 to 60% by weight, with respect to the total weight of the anti-vibration sealer composition. When the content of the epoxy resin is less than about 30% by weight, the stiffening effect may be reduced, and when the content is greater than about 70% by weight, stiffness may be increased excessively thereby causing fractures or cracks and peeling-off, and thus, manufacturing processes may be difficult to carry out due to decreased discharging property.

(2) Epoxy Curing Agent

As used herein, an epoxy curing agent may cure the epoxy resin. Various types of epoxy curing agents generally used in the related field may be used without limitation as the epoxy curing agent in the present invention. For example, dicyandiamide (DICY) may be used according to an exemplary embodiment of the present invention to effectively preventing rapid decrease in penetration property when an anti-vibration sheet is stored at room temperature.

The anti-vibration sealer composition of the present invention may include the epoxy curing agent in an amount of about 3 to 10% by weight, or particularly, in an amount of about 5 to 7% by weight, with respect to the total weight of the anti-vibration sealer composition. When the content of the epoxy curing agent is less than about 3% by weight, a curing speed may decrease or curing may not be completed, which may further generate problems such as reducing in hardness and adhesive strength. When the content is greater than about 10% by weigh, the composition may be readily peeled-off, storage stability and penetration may be reduced.

(3) Tackifier

A tackifier may be included in the anti-vibration sealer composition, such that an anti-vibration material may be attached to regions of application. The tackifier may be used with one or more types selected from among a silane-based tackifier, an isocyanate-based tackifier, a dicyandiamide-based tackifier, a polyamine-based tackifier and an epoxy resin-based tackifier. Exemplary tackifier may be, but not limited to, a silane-based tackifier.

The anti-vibration sealer composition of the present invention may include a tackifier in an amount of about 3 to 5% by weight with respect to the total weight of the anti-vibration sealer composition. When the content of the tackifier is less than about 3% by weight, a stiffness property may deteriorate due to reduced adhesive power, and when the content is greater than about 5% by weight, adhesive power may be increased substantially, however, a spray workability may be hindered since viscosity increases when the composition is left unattended for a long period of time.

(4) Filler

As described above, the calcium carbonate doublecoated with organic resins may be used as a filler in order to enhance an anti-vibration property as well as enhance mechanical properties of the anti-vibration sealer composition.

The double coated calcium carbonate used as a filler may be prepared by first coating the outer surface of calcium carbonate particles with nitrile butadiene rubber (NBR), and then second coating over the first coating layer with an acrylic resin. As a result, product weight may be reduced reduction and further, an anti-vibration property may be substantially improved due to a density decrease compared to a conventional anti-vibration sealer including calcium carbonate particles as a filler.

The anti-vibration sealer composition of the present invention may use the double coated calcium carbonate as the filler. However, the filler may also partly include one or more types of, for example, calcium carbonate, aluminum hydroxide, barium sulfate, clay, silica and mica.

The anti-vibration sealer composition of the present invention includes the filler in an amount of about 15 to 40% by weight, or particularly. in an amount of about 20 to 30% by weight with respect to the total weight of the anti-vibration sealer composition. When the content of the filler is less than about 15% by weight, sufficient improvement of anti-vibration performance may not be obtained, and when the content is greater than about 40% by weight, shearing strength may be reduced.

(5) Other Additives

The present invention may further include suitably selected additives which may be generally used in the related field, such as anti-vibration material manufacturing field. Exemplary additives may be a water absorbing agent, an anti-sagging agent, a stabilizing agent and the like.

The water absorbing agent may be used in order to remove moisture in a product. For example, calcium oxide (CaO) that maintains a heat-generating temperature of about 90° C. or greater with moisture may be used as the water absorbing agent, such that high purity capable of controlling moisture may be maintained even when the product is stored for a long period of time. The water absorbing agent may be included in the anti-vibration sealer composition in an amount less than about 10% by weight with respect to the total weight of the anti-vibration sealer composition, or particularly an amount of about 1 to 10% by weight of the water absorbing agent with respect to the total weight anti-vibration sealer composition may be included. As such, the water absorbing agent contained in the anti-vibration sealer composition may effectively increase storage stability by suppressing moisture contact, however, when the content is greater than about 10% by weight, a serious efflorescence phenomenon may occur when the composition is cured, and may cause deterioration of stiffness property.

The anti-sagging agent may be used for improving the processibility of products in the anti-vibration sealer composition. For example, bentonite may be used as the anti-sagging agent, but the examples of the anti-sagging agent may not be limited thereto. The anti-sagging agent may be included in an amount less than about 5% by weight with respect to the total weight of the anti-vibration sealer composition, or particularly, the anti-sagging agent in an amount of about 3 to 5% by weight with respect to the total weight of the anti-vibration sealer composition may be included. When the content of the anti-sagging agent is greater than about 5% by weight, processibility may be reduced.

The stabilizing agent may also be used for stabilizing products, or preventing discoloration and ageing. Exemplary stabilizing agent may be metal oxides of barium, zinc, calcium, lead, tin and the like or metal organic acid salts but the examples may not be limited thereto. The stabilizing agent may be included in the anti-vibration sealer composition in an amount less than about 5% by weight, or particularly, in an amount of about 1 to 2% by weight, with respect to the total weight of the anti-vibration sealer composition. When the content of the stabilizing agent is greater than about 5% by weight, the curing of the composition may be suppressed.

According to various exemplary embodiments of the present invention, the epoxy-based anti-vibration sealer composition may obtain improved mechanical properties such as stiffness and have substantially improved anti-vibration property as well. As such, the epoxy-based anti-vibration sealer composition may be used for anti-vibration in parts inducing vibrations and/or noises in vehicles and the like. FIG. 2 shows an exemplary sheet that is prepared using an exemplary epoxy-based anti-vibration sealer composition according to an exemplary embodiment of the present invention.

The present invention will be described in more detail with reference to the following examples, however, the present invention is not limited thereto.

### EXAMPLES

### Preparation Example

### Preparation of Double Coated Calcium Carbonate

About 50 g of calcium carbonate particles having a particle diameter of about 50 μm were deposited to a first coating solution including about 20 g of nitrile butadiene rubber (NBR) and about 70 g of butyl cellosolve, and the result was stirred for about 2 hours. The calcium carbonate particles were taken out from the first coating solution, and cured for about 20 minutes at a temperature of about 140° C. to obtain NBR-coated calcium carbonate particles.

About 70 g of the NBR-coated calcium carbonate particles prepared above were deposited to a second coating solution including about 20 g of an acrylic resin and about 70 g of butyl cellosolve, and the result was stirred for about 2 hours. The calcium carbonate particles were taken out from the second coating solution, and cured for about 30 minutes at a temperature of about 140° C. to obtain calcium carbonate particles doublecoated with the NBR and the acrylic resin.

### Examples 1 to 4 and Comparative Examples 1 to 3

### Preparation of Anti-Vibration Sealer Composition

Examples 1 to 4 and Comparative Examples 1 to 3 are for comparing anti-vibration properties of anti-vibration sealer compositions prepared by varying the content of calcium carbonate particles or the double coated calcium carbonate prepared using the preparation example included in the epoxy-based anti-vibration composition as a filler.

The constituents listed in Table 1 were mixed in the content ratio shown in Table 1, and test pieces were prepared in accordance with Hyundai Motor Company Test Standard MS 721-60. Anti-vibration sealer compositions were prepared by melting the prepared test pieces at about 140 to 150° C., and anti-vibration properties were measured using a test method of MS 731-06. The results are shown in the following Table 1.

TABLE 1

| | | Example | | | | Comparative Example | | |
|---|---|---|---|---|---|---|---|---|
| Category | | 1 | 2 | 3 | 4 | 1 | 2 | 3 |
| Bisphenol A Epoxy | | 50 | 50 | 50 | 50 | 50 | 50 | 50 |
| Resin | | | | | | | | |
| (% by weight) | | | | | | | | |
| Dicyandiamide | | 8 | 8 | 8 | 8 | 8 | 8 | 8 |
| (% by weight) | | | | | | | | |
| Silane-Based Tackifier | | 3 | 3 | 3 | 3 | 3 | 3 | 3 |
| (% by weight) | | | | | | | | |
| Filler | Calcium | 0 | 5 | 10 | 15 | 30 | 25 | 20 |
| | Carbonate | | | | | | | |
| | (% by | | | | | | | |
| | weight) | | | | | | | |
| | Double | 30 | 25 | 20 | 15 | 0 | 5 | 10 |
| | Coated | | | | | | | |
| | Calcium | | | | | | | |
| | Carbonate | | | | | | | |
| | (% by | | | | | | | |
| | weight) | | | | | | | |

| | | | | | | | |
|---|---|---|---|---|---|---|---|
| Calcium Oxide | 5 | 5 | 5 | 5 | 5 | 5 | 5 |
| (% by weight) | | | | | | | |
| Bentonite | 3 | 3 | 3 | 3 | 3 | 3 | 3 |
| (% by weight) | | | | | | | |
| Tin Oxide | 1 | 1 | 1 | 1 | 1 | 1 | 1 |
| (% by weight) | | | | | | | |
| Total Amount | 100 | 100 | 100 | 100 | 100 | 100 | 100 |
| (% by weight) | | | | | | | |
| Anti-Vibration Property | 0.12 | 0.11 | 0.09 | 0.07 | 0.02 | 0.03 | 0.04 |
| (20° C., Target Value | | | | | | | |
| 0.07 or Greater) | | | | | | | |

### Test Example

In the test example, the anti-vibration sealer compositions prepared in Example 3 and Comparative Example 1 were prepared into test pieces, and physical properties required as an anti-vibration sealer were compared. The results are shown in the following Table 2.

TABLE 2

| | | | Comparative | |
|---|---|---|---|---|
| Category | Requirement | Test Method | Example 1 | Example 3 |
| Specific | 1.43 ± 0.1 | Specific Gravity Cup Method | 1.44 | 1.39 |
| Gravity | | | | |
| Viscosity | 250,000 to | Rotary Viscometer | 240,000 | 250,000 |
| (cPS) | 300,000 | 20 rpm, Spindle 7 | | |
| Solid | 99 or Greater | Residual Quantity after 105° C. × | 99.0 | 99.2 |
| Content (%) | | 3 hours | | |
| Flowability | 3 or Less | Sealer is applied to a size of | 0 | 0 |
| (mm) | | 75 × 150 mm on the center of a | | |
| | | steel sheet of 100 × 300 mm, and | | |
| | | then the result was left | | |
| | | unattended for 4 hours at room | | |
| | | temperature | | |
| Pre-treating | No Adhesive | 5 g of the sealer per 4 L of a | Favorable | Favorable |
| Liquid | Dissolution and | 55° C. degreasing solution and a | | |
| Contamination | Liquid | chemical conversion liquid was | | |
| | Contamination. | deposited, and then the result | | |
| | | was left unattended for 4 hours | | |
| Pre-painting | No Adhesive | 5 g of the sealer per 4 L of a | Favorable | Favorable |
| Liquid | Dissolution and | room temperature pre-painting | | |
| Contamination | Liquid | liquid was deposited, and then | | |
| | Contamination. | the result was left unattended for | | |
| | | 1 hour | | |
| Shear | 3 or Greater, | 180 degree peel-off at a rate of 5 mm/ | 3.4 | 3.3 |
| Adhesive | Cohesive Failure | minute using a tensile tester | | |
| Strength | 70% or Greater | | | |
| (MPa) | | | | |
| Flexural | 5 to 6 kgf | Sealer is applied on one surface | 5.5 | 5.6 |
| Rigidity | | of a steel sheet of 25 × 150 × 0.75 mm, | | |
| (kgf) | | and then a maximum weight | | |
| | | was calculated by applying a | | |
| | | load at a rate of 5 mm/minute | | |
| | | using a tensile tester | | |
| Anti-vibration | 0.07 or Greater | Sealer was applied to a thickness | 0.02 | 0.09 |
| Property | | of 1.5 mm on a steel plate of | | |
| | | 200 × 20 mm, and then an | | |
| | | anti-vibration property was | | |
| | | measured using an OBERST | | |
| | | BAR | | |
| Impact | 10 or Greater | Sealer was applied to a size of | 15 | 15 |
| Resistance | | 100 × 50 mm on a steel plate of | | |
| | | 300 × 100 mm, and impact was | | |
| | | applied using an impact tester | | |

Accordingly, when the anti-vibration sealer composition uses an epoxy resin as a base resin, substantially improved mechanical properties such as impact resistance and flexural rigidity. Further, when the anti-vibration sealer composition includes the double-coated calcium carbonate as a filler, anti-vibration property may be substantially improved.

In addition, the anti-vibration sealer composition of the present invention may have reduced specific gravity compared to a conventional anti-vibration material including a calcium carbonate filler, such that the weight of a product, e.g. a vehicle part, may be reduced.

The invention has been described in detail with reference to various exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A filler for an epoxy-based anti-vibration sealer, comprising:
calcium carbonate that comprises: 1) a nitrile butadiene rubber (NBR) coating layer and 2) an acrylic resin coating layer in consecutive order on a surface of the calcium carbonate.

2. The filler of claim 1, wherein 1) the nitrile butadiene rubber (NBR) coating layer and 2) the acrylic resin coating layer are laminated in consecutive order on particles of the calcium carbonate.

3. The filler of claim 1, wherein the filler comprises the nitrile butadiene rubber (NBR) coating layer in an amount of about 10 to 50% by weight with respect to the total weight of the calcium carbonate, and the acrylic resin coating layer in an amount of about 10 to 50% by weight with respect to the total weight of the calcium carbonate.

4. A method for preparing a filler for an epoxy-based anti-vibration sealer, comprising:
preparing nitrile butadiene rubber (NBR)-coated calcium carbonate particles; and
preparing double-coated calcium carbonate particles from the NBR-coated calcium carbonate particles.

5. The method of claim 4, wherein the nitrile butadiene rubber (NBR)-coated calcium carbonate particles are prepared by steps comprising:
depositing calcium carbonate particles in a first coating solution comprising nitrile butadiene rubber (NBR) in an amount of about 20 to 50% by weight and butyl cellosolve in an amount of about 50 to 80% by weight based on the total weight of the first coating solution;
removing the calcium carbonate particles from the first coating solution;
heat curing the calcium carbonate particles for about 15 to 30 minutes at a temperature of about 130 to 140° C.

6. The method of claim 4, wherein the double-coated calcium carbonate particles are prepared by steps comprising:
depositing the NBR-coated calcium carbonate particles in a second coating solution comprising an acrylic resin in an amount of about 20 to 50% and butyl cellosolve in an amount of about 50 to 80% by weight based on the total weight of the second coating solution;
removing the calcium carbonate particles from the second coating solution; and
heat curing the calcium carbonate particles for about 15 to 30 minutes at a temperature of about 130 to 140° C.

7. An epoxy-based anti-vibration sealer composition, comprising:
an epoxy resin;
epoxy curing agent;
a tackifier;
a filler; and
an additive,
wherein the filler comprises calcium carbonate that comprises 1) a nitrile butadiene rubber (NBR) coating layer and 2)an acrylic resin coating layer in consecutive order on a surface of the calcium carbonate.

8. The epoxy-based anti-vibration sealer composition of claim 7, wherein for the filler, 1) the nitrile butadiene rubber (NBR) coating layer and 2) the acrylic resin coating layer are laminated in consecutive order on particles of the calcium carbonate.

9. The epoxy-based anti-vibration sealer composition of claim 7, wherein an amount of the nitrile butadiene rubber (NBR) coating layer is from 10 to about 50% by weight, and an amount of the acrylic resin coating layer is from about 10 to about 50% by weight with respect to the total weight of the calcium carbonate.

10. The epoxy-based anti-vibration sealer composition of claim 7 comprising the epoxy resin in an amount of about 30 to 70% by weight, the epoxy curing agent in an amount of about 3 to 10% by weight, the tackifier in an amount of about 3 to 5% by weight, the filler in an amount of about 15 to 40% by weight, and the additive in an amount of about 1 to 15% by weight, with respect to the total weight of the epoxy-based anti-vibration sealer composition .

11. The epoxy-based anti-vibration sealer composition of claim 7, wherein the epoxy resin is a bisphenol A-type epoxy resin.

12. The epoxy-based anti-vibration sealer composition of claim 7, wherein the epoxy curing agent is dicyandiamide.

13. The epoxy-based anti-vibration sealer composition of claim 7, wherein the tackifier is one or more selected from the group consisting of a silane-based tackifier, an isocyanate-based tackifier, a dicyandiamide-based tackifier, a polyamine-based tackifier, and an epoxy resin-based tackifier.

14. The epoxy-based anti-vibration sealer composition of claim 7, wherein the additive is one or more selected from a water absorbing agent, an anti-sagging agent and a stabilizing agent.

15. An anti-vibration sheet comprising the epoxy-based anti-vibration sealer composition of claim 7.

16. The anti-vibration sheet of claim 15, which is used in a vehicle.
